(19) United States
(12) Patent Application Publication
(10) Pub. No.: US 2022/0186453 A1
(43) Pub. Date: Jun. 16, 2022

(54) Soil Compaction Device

(71) Applicant: Wacker Neuson Produktion GmbH & Co. KG, Reichertshofen (DE)

(72) Inventor: Michael Steffen, Munich (DE)

(21) Appl. No.: 17/549,259

(22) Filed: Dec. 13, 2021

(30) Foreign Application Priority Data
Dec. 14, 2020 (DE) 10 2020 133 340.4

(51) Int. Cl. E02D 3/032; B60K 6/20; B60L 1/00; B60L 7/10; B60L 50/51; B60L 53/80; B60W 30/18; E01C 19/28; E01C 19/27; E01C 19/26

(52) U.S. Cl. CPC E02D 3/032; B60K 6/20; B60L 1/003; B60L 7/10; B60L 50/51; B60K 2016/003; B60W 30/18127; E01C 19/282; E01C 19/27; E01C 19/26; B60L 53/80

(57) ABSTRACT

A compaction device for compacting a soil region includes at least one vibration unit and/or oscillation unit able to be driven by an electric drive motor. A soil contacting unit comprises at least one soil contacting element in contact with the soil region. The soil contacting unit comprises at least the electric drive motor and the vibration unit and/or the oscillation unit. At least one power supply unit supplies the electric drive motor with electric drive power. At least one electric plug device for releasably and electrically connecting the electric drive motor is provided between the electric drive motor and the power supply unit. At least one fixing device for releasably and mechanically fixing to the power supply unit is provided between the soil contacting element of the soil contacting unit and the power supply unit.

### BACKGROUND OF THE INVENTION

### 1. Field of the Invention

The invention relates to a soil compaction device for compacting a soil region, in particular vibratory rammers, vibratory plates or rollers, having an electric motor for driving a driven device such as a compaction unit or an oscillation unit.

### 2. Description of the Related Art

Soil compaction devices for compacting a soil region, such as vibratory runners, vibratory plates or rollers, etc., are already known in general, e.g. from EP 1 097 272, and have been used for decades on various construction sites. Above all, rammers and vibratory plates comprise an upper mass having a motor, i.e. in general an internal combustion engine or an electric motor, and a lower mass which is movable relative to the upper mass and has the ramming foot, or the soil plate, respectively. The relative movement between the upper mass and the lower mass is in most instances damped via spring packs.

Accordingly, rammers or vibratory plates are construction equipment which is used mobile manner and, usually by way of centrifugal force exciters on the lower mass, introduces mechanical energy into the soil and as a result displace and compact the latter. The drive of the centrifugal force exciters takes place by gasoline or diesel engines or electric motors which are typically disposed on the upper mass, the latter being elastically coupled to the lower mass.

The transmission of force from the drive source takes place by V-belts, hydraulic systems, flexible shafts, or else by electric lines. The V-belts which have been customary to date and are utilized for transmitting the mechanical power from the drive source to the lower mass are subject to heavy wear and tear during operation. Hydraulic systems can be implemented only in a highly cost-intensive manner which is deficient in terms of efficiency.

Already known from publication DE 2 321 761 A, however, is a vibratory plate, wherein the oscillation excitation is firmly fixed to the soil plate, or base plate, respectively, i.e. is comprised by the lower mass, and is elastically connected to the upper mass by way of electric lines. The oscillation excitation here takes place via two electric drive motors which are supplied with electric power from the upper mass, the latter having an internal combustion engine and a fuel tank, as well as via an electric generator.

These commercially available soil compaction machines are of a highly stable and compact construction in order to be able to withstand the rough and dirty construction site conditions, or the high mechanical stress even over a long period. To this end, all necessary components are combined so as to form a stable overall apparatus, wherein the fuels such as gasoline, diesel, charged batteries, etc. are added, depending on the drive mode.

The use of the vibratory plates in different environments (interior/exterior) demands different concepts, such as gasoline or diesel for outdoors, electric drives for indoors. Accordingly, special machines have to be kept available in each case for the different environments.

### SUMMARY OF THE INVENTION

In contrast to the above, it is an object of the invention to propose a soil compaction device which at least partially improves the disadvantages of the prior art, in particular significantly increases the flexibility and at the same time can be economically implemented.

Accordingly, a soil compaction device according to the invention includes a driven device comprising at least one of a vibration unit and an oscillation unit. An electric motor is configured to drive the driven device. The electric drive motor is configured as one of an electric linear motor and as an electric motor having a rotor rotatable about a rotation axis. At least one power supply unit supplies the electric drive motor with electric power. At least one of an electric plug device and a first coupling device that releasably and electrically couples the electric drive motor and the power supply unit and that is provided between the electric drive motor and the power supply unit. A soil contacting unit is provided that includes at least one soil contacting element, with the soil contacting element being configured to contact the soil region. The soil contacting unit comprises at least the electric drive motor and the driven device. At least one of a fixing device and a second coupling device is/are provided for releasably and for mechanically coupling the soil contacting element of the soil contacting unit to the power supply unit. The at least one of the fixing device and the second coupling device is provided between the soil contacting element of the soil contacting unit and the power supply unit.

With the aid of the electric plug device or first coupling device, respectively, and the fixing device or a second coupling device, respectively, it is advantageously achieved that the soil contacting unit is configured as a replaceable and/or standardized soil contacting unit such that different power supply units are able to be used/inserted according to the requirement or parameters, respectively. The most varied soil compaction devices which are able to be flexibly adapted to the most varied specific applications can thus be implemented/configured.

At least one electric cable, in particular a flexible cable, is advantageously provided between the electric plug device or first coupling device, respectively, and the electric drive motor, and/or the fixing device or second coupling device, respectively, comprises at least one damping element, in particular a spring and/or rubber element. In this way, the relative movement between the soil contacting unit and the power supply unit caused by the oscillations/vibrations can thus be advantageously compensated for with a view to the electric power transmission, on the one hand, and/or with a view to the mechanical coupling/linking/connection, on the other hand.

In one advantageous embodiment of the invention the electric connection/coupling can be implemented by a plug, or by fixedly connected/plugged cables. In one advantageous alternative variant, the electric connection can also be implemented in a magnetic and/or capacitive manner, for example, i.e. so as to be “wireless” or “contactless”, respectively.

The two components of the electric connection or of the first coupling device, respectively, to be connected, for example the plug and the socket, can advantageously magnetically adhere/hold on to one another, on the one hand, and/or the current, or the electric power, respectively, for the drive motor or for the soil module, respectively, by way of the two components to be connected can be advantageously transmitted by way of magnetic contact faces of the plug device or first coupling device according to the invention, on the other hand.

For example, the fixing device or a second coupling device, respectively, comprises at least one fixing element which is preferably configured as a bolt, a pin, a screw, a nut, a tensioning or clamping element, respectively, or the like.

One component assembly can optionally be provided for the electric power transmission/power connection and/or for the mechanical coupling/linking/connection, on the other hand. However, a spacing is preferably provided between the electric plug device and the fixing device such that the electric plug device and the fixing device are configured as separate component assemblies/devices. In this way, the electric power transmission/connection and the mechanical coupling/linking/connection can in each case be separately optimized. This is highly advantageous specifically with a view to the high mechanical, dynamic stresses that act on the fixing device or second coupling device, respectively. Also as a result thereof, an advantageous replacement of damaged or compromised components, respectively, can be performed when required. This substantially improves the service life and thus also the economy of the soil compaction device according to the invention.

In one advantageous variant of the invention, the energy supply unit has at least one support frame, wherein at least one handle for holding the soil compaction device during an operation phase is disposed in particular on the support frame. This improves the stability and the manageability of the soil compaction device according to the invention.

The energy supply unit and/or the support frame advantageously have/has at least first fixing device of the fixing device, and the soil contacting unit has at least second fixing device, wherein the first and the second fixing device are able to be releasably fixed to one another. In this way, advantageous, releasable connecting/fixing/linking/coupling of the soil contacting unit and the energy supply unit is able to be implemented.

At least two, or a plurality of, respectively, first/second fixing devices are preferably provided, wherein (established and/or standardized) fixing spacings are provided between the first fixing device or between the second fixing device, respectively. As a result, various or different, respectively, energy supply units having first fixing device can be implemented, with the energy supply units being placed onto the second fixing device or the soil contacting unit, respectively, or being fixedly connected thereto for the operation.

In one particular refinement of the invention, the soil contacting unit is configured as a separately manageable soil module, and the energy supply unit is configured as a separately manageable, replaceable power module. This modularity enables a particularly flexible use of the soil compaction device according to the invention.

Standardized or uniform, respectively, electric plug devices or first coupling devices, respectively, and fixing devices or second coupling devices, respectively, are advantageously provided. This improves the economy of the invention yet again. Identical parts or standard parts, respectively, for the most varied soil compaction devices thus advantageously reduce the costs. Only the energy supply units can be configured in the most varied manner, for example as an electric power source, or power supply unit, respectively, or as an energy supply unit which is operated with fuel, in particular diesel or gasoline or natural gas with an electric generator, and/or as a fuel cell unit (FC), in particular as FC units which are operated with hydrogen, methane, oxygen, air or the like.

The power supply unit preferably comprises at least one rechargeable electric storage unit. The electric storage unit, in particular a battery or a rechargeable accumulator or the like, respectively, can be used for supplying power, or as an electric power source for the electric drive motor(s) and/or for further/other electric consumers such as, for example, starter/motor or lights/headlights, etc., respectively.

In one advantageous variant of the invention, the power supply unit comprises at least one inverter for converting DC to AC. In this way, a DC voltage of the electric storage unit, or accumulator, respectively, can for example be converted to an advantageous AC voltage of the electric drive or electric motor, respectively. The flexibility of the soil compaction device according to the invention is thus further improved.

The power supply unit advantageously comprises at least one mains cable for connecting to a grid. The electric storage unit can be replenished, preferably via an electric charging apparatus, using the advantageous mains connector, on the one hand On the other hand, the electric drive, in particular the electric motor and/or the electric linear motor, can be supplied directly with electric power such that for example a temporary storage of electricity in the storage unit/accumulator and/or a generation of electric power via the internal combustion engine by way of an electric generator or via a fuel cell, respectively, can be dispensed with or be used in mutual combination. Accordingly, this advantageous measure also increases the flexibility of the soil compaction device according to the invention.

The power supply unit or the power module, respectively, preferably comprises a so-called range extender or an ancillary apparatus. The operating period can be extended in this way. For example, an ancillary electric storage unit and/or an ancillary tank for the internal combustion engine or the fuel cell is present, and/or an additional, in particular comparatively smaller, internal combustion engine having an additional electric ancillary generator and/or an additional, in particular comparatively smaller, fuel cell module are/is present. This also leads to an improvement in terms of the flexibility of the potential applications.

For example, the so-called range extender, or the ancillary apparatus, respectively, is used and/or electrically wired/incorporated in series or in parallel with the power supply or the other power supply units, respectively. This in turn enables a particular adaptability to the most varied external parameters when using the soil compaction device according to the invention.

In principle, it may be advantageous for the drive motor to be fixedly installed in the soil module or the soil contacting unit, respectively, and for the power supply such as, for example the electric storage unit, and/or the internal combustion engine having the energy converter to form a separate component assembly which is removable from the soil module or the soil contacting unit, respectively, wherein a releasable coupling device is provided at least between the power supply, or the power supply unit, respectively, and the electric drive motor. With the aid of this measure, the internal combustion engine which requires relatively frequent maintenance or is susceptible to defects, respectively, with the power converter can be removed without great complexity from the soil module or the soil contacting unit, respectively, and later be reconnected, for instance after having been serviced or repaired. In the case of comparatively complex and time-intensive servicing, or for relatively time-consuming repairs, respectively, a second component assembly can optionally be used or provided, respectively, without great complexity as a replacement for the component assembly to be serviced or repaired, respectively, such that the soil module, or the soil contacting unit, respectively, is already fully ready for use again after a comparatively short modification phase.

It is thus also guaranteed here, for example in the case of a defect of the internal combustion engine, that the soil module, or the soil contacting unit, respectively, with the drive motor can continue to be operated and be advantageously driven/moved to a maintenance base or the like. Subsequently, the defective internal combustion engine according to the invention is optionally replaced in a comparatively rapid manner by a corresponding replacement unit or by a charged battery module, etc. As a result, the soil module, or the soil contacting unit, respectively, is able to be very quickly used again without limitation.

Excess propulsion power potentially generated during the operation of the internal combustion engine can advantageously be used for charging the power storage unit, in particular using commercially available standard components. As a result, separate charging of the rechargeable batteries can advantageously be dispensed with, for example.

In one advantageous variant of the invention, the plug device is configured as a plug coupling device having at least one plug and one socket. Plug-coupling devices of a corresponding configuration enable the component assembly to be connected to, or released from, the soil module and/or the soil contacting unit in a particularly simple or rapid manner, respectively. Commercially available standard components already present for corresponding electric plugs or sockets, respectively, can be resorted to here such that the invention is able to be implemented in a comparatively economical manner.

The plug device is advantageously configured as a power coupling and/or control coupling for coupling power lines and/or control lines or control signals, respectively. Separate powerlines and control lines are optionally provided. In general, comparatively high electric voltages or currents, respectively, are used for supplying the drive motor with power. In contrast, comparatively minor electric voltages or currents, respectively, are used for controlling the drive/compaction components by open or closed loop, respectively, for example using control voltages of approx. 12 or 24 Volts. Separate lines or couplings, respectively, of corresponding size can be provided to this end.

In one particular variant of the invention, the power supply unit, or the power module, respectively, has at least one storage element for storing a combustible or fuel, respectively, of the internal combustion engine and/or starter device for starting the internal combustion engine. A largely autonomous operating mode of the power supply unit, or of the power module, respectively, according to the invention is able to be implemented in this way, such that the servicing or repairing, respectively, of the components of the internal combustion engine that are relatively highly susceptible to defects can advantageously take place. The largely autonomous power supply unit, or the power module, respectively, here can be separately managed and/or the functionality thereof can be almost completely verified or checked, respectively, without compromising the soil contacting unit or the soil module, respectively.

The starter device preferably has the electric storage unit, or a separate/special battery or rechargeable battery, respectively, for storing electric power for the starting procedure of the internal combustion engine. For example, at least two separate batteries or rechargeable batteries, respectively, are provided, wherein in one rechargeable battery is provided for starting the internal combustion engine, and at least the second rechargeable battery is provided for supplying power to the drive motor of the soil contacting unit or the soil module, respectively.

The power supply unit, or the power module, respectively, is advantageously configured as an autonomous emergency/back-up power unit. A dual function of the power supply unit, or of the energy module, respectively, can thus be implemented in an advantageous manner. A power supply unit according to the invention, or the power module, respectively, can thus be used/deployed for supplying power to the soil contacting unit or the soil module, respectively, on a construction site or at a deployment location, respectively, on the one hand.

Moreover, the power supply unit according to the invention, or the energy module, respectively, can be used as an autonomous emergency/back-up power unit for other construction machinery or plant equipment, respectively, and/or as a charging station for charging rechargeable electric storage units or accumulators, respectively, when the soil compaction device, i.e. the soil contacting unit or the soil module, respectively, is stopped or out of operation, respectively. A particularly economical operating mode and function can be implemented in this way.

With a view to a separate use of the power supply unit according to the invention, or of the power module, respectively, as an autonomous emergency/back-up power unit, at least one soil frame having fixing means of the fixing device is optionally advantageous so as to be able to be separately set up in an advantageous manner, in particular on a dirty construction site. The fixing means of the power supply unit, or of the power module, respectively, are advantageously not soiled and/or damaged in this way.

At least one connection unit is preferably provided as the plug device according to the invention for a/the (rechargeable) electric storage unit, said connection unit being able to be releasably connected (without tools), wherein the plug device or connection unit, respectively, comprises at least one electric contacting device for contacting the (rechargeable) electric storage unit, said contacting being in a releasably connectable manner (without tools), and at least one holding device for holding the (rechargeable) electric storage unit preferably in a housing and/or frame of the power supply unit, said holding being in a releasably connectable manner (without tools), said holding device being able to be releasably connected (without tools).

With the aid of a plug device or connection unit, respectively, of this type which is releasably connectable without tools, the (rechargeable) electric storage unit can now be replaced without great complexity, or without tools, respectively, when required. This opens up entirely novel operating possibilities of the soil compaction device. A discharged, or almost discharged, respectively, first electric storage unit can thus be advantageously replaced, wherein another, or second, respectively, charged electric storage unit via the plug device or connecting unit according to the invention, respectively, can be installed in the current or power supply unit, or be connected to the latter, preferably without tools.

Electric power for the drive motor is thus available again immediately and very rapidly, i.e. without lengthy charging times. This is a decisive advantage specifically for a comparatively long use of vibrators, rammers, rollers, vibratory plates, etc., on a construction site or the like. For example, an almost unlimited power supply for this construction equipment or the like can be guaranteed using a plurality of, for example approx. 5 or 10 charged, replaceable electric storage units. This opens up potential applications for powerful soil compaction devices that have not yet been able to be implemented, specifically in the construction industry.

An electric charging device for charging the rechargeable electric storage unit is advantageously provided, wherein the charging device comprises at least one electric and/or electronic charge controller for controlling a charging procedure of the rechargeable electric storage unit, wherein the charge controller is configured as an AC/DC converter for converting the first AC voltage to a DC voltage of the rechargeable electric storage unit, wherein the connector unit is configured as an AC voltage input of the charge controller. In this way, the rechargeable electric storage unit can not only be rapidly replaced but also be advantageously charged when required, or in sufficient time, for example overnight or over the lunch break, etc. Accordingly, the stocking or use, respectively, of a plurality of rechargeable electric storage units can be dispensed with. This saves inter alia investment and other costs.

The power supply unit, or the power module, respectively, and/or the connector unit preferably has at least one mains connector for a mains voltage, for example of approx. 115 V at 60 Hz and/or a single-phase mains voltage of approx. 230 V at 50 Hz and/or a so-called three-phase alternating current of approx. 400 V at 50 Hz, and/or a low-voltage connector, for example 24 V or approx. 35 to 50 V, such as approx. 42 V/48 V at 200 Hz, in particular.

### BRIEF DESCRIPTION OF THE DRAWINGS

An exemplary embodiment of the invention is illustrated in the drawing and will be explained in more detail hereunder via the figures.

FIGS. 1A and 1B show a first vibratory plate according to the invention illustrated in a schematic manner, having an internal combustion engine with an electric generator as the power supply of a soil module;

FIGS. 2A and 2B shows a second vibratory plate according to the invention illustrated in a schematic manner, having an internal combustion engine with an electric generator as well as having a current converter as the power supply of the soil module;

FIGS. 3A and 3B show a third vibratory plate according to the invention illustrated in a schematic manner, having at least one electric storage unit as well as optionally having a current converter as the power supply of the soil module;

FIGS. 4A and 4B show a fourth vibratory plate according to the invention illustrated in a schematic manner, having the internal combustion engine with an electric generator as well as having a current converter and having an electric storage unit as the energy supply of the soil module;

FIGS. 5A and 5B show a fifth vibratory plate according to the invention illustrated in a schematic manner, having at least one electric storage unit as well as a mains connector and optionally having a current converter as the power supply of the soil module;

FIGS. 6A and 6B show a sixth vibratory plate according to the invention illustrated in a schematic manner, having a current converter and having a mains connector as well as optionally having a current converter as a power supply of the soil module;

FIG. 7 shows a first rammer according to the invention illustrated in a schematic manner, having at least one electric storage unit as well as optionally having a current converter as the energy supply of a rammer soil module; and

FIG. 8 shows a second rammer according to the invention illustrated in a schematic manner, having an internal combustion engine with an electric generator as well as optionally having a current converter as the power supply of the rammer soil module.

### DETAILED DESCRIPTION

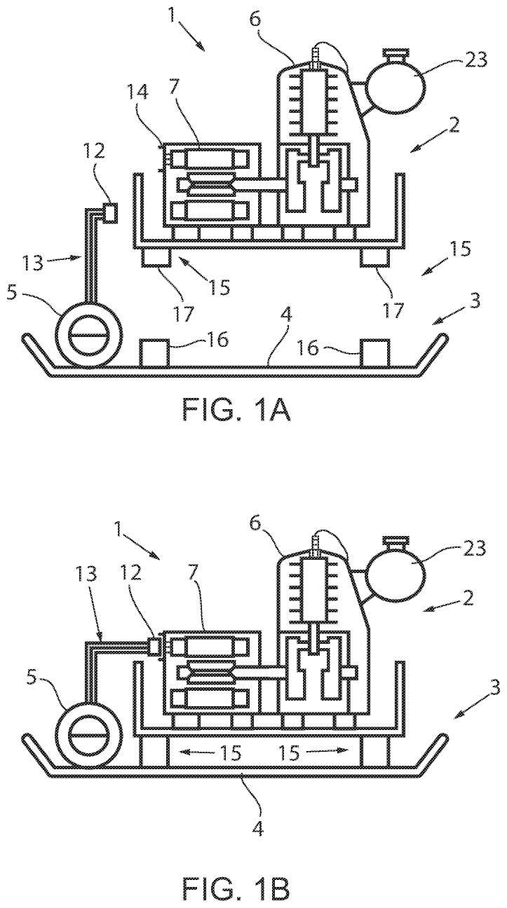

Illustrated in a schematic manner in FIGS. 1A to 6B are different vibratory plates 1 having different power supply modules 2 as well as the same or identical, respectively, soil module 3 in a connected state/operation, on the one hand, and in the mutually released/separated state, on the other hand.

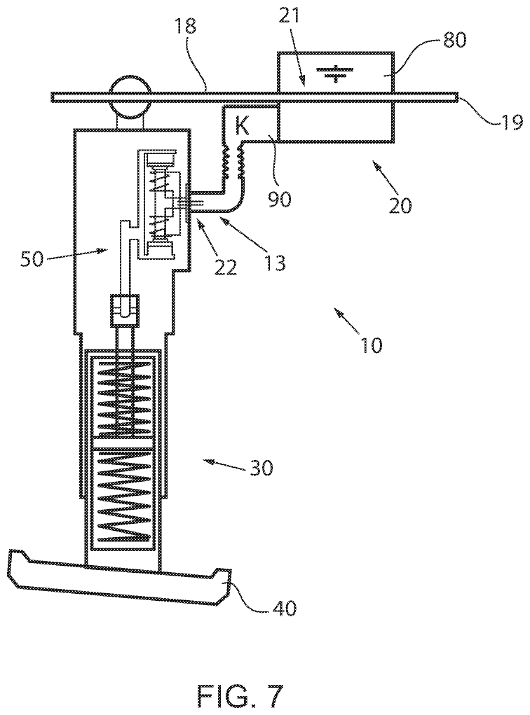

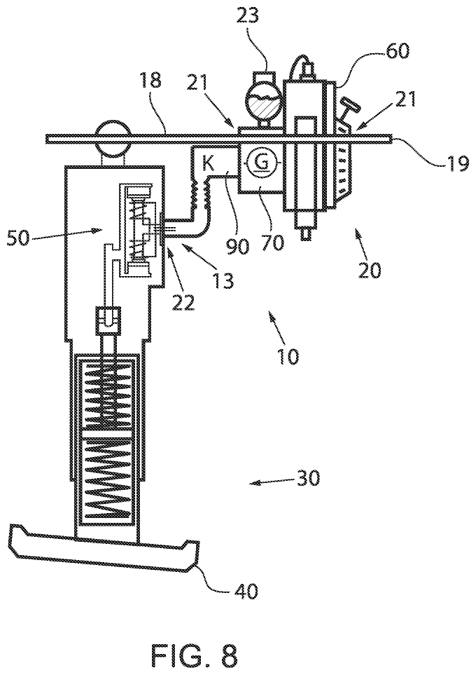

Accordingly illustrated in a schematic manner in FIGS. 7 and 8 are different rammers 10 having different power supply modules 20 as well as the same or identical, respectively, rammer soil module 30 in a connected state/operation, on the on the one hand, and in a mutually released/separated state, on the other hand.

The soil modules 3, or rammer soil modules 30, respectively, thus have in each case a soil plate 4 or 40, respectively, as well as in each case at least one oscillation or a vibration exciter 5 or 50, respectively, having an electric drive motor.

The soil module 3 of the vibratory plates 1, or the rammer base module 30 of the rammers 10, respectively, are in each case of identical configuration. Only the power supply, or the respective power supply module 2 or 20, respectively, are of different configurations. A replacement of the respective power supply modules 2 or 20, respectively, can thus be advantageously implemented.

According to FIGS. 1A and 1B, an internal combustion engine 6 drives an electric generator 7 which supplies electric power suitable for directly driving an electric motor of the exciter or exciters 5. Individual exciters 5 or combinations of a plurality of exciters 5 are possible. Optionally, an electric motor as the drive of the oscillation exciter 5 can also be part of this exciter 5 per se.

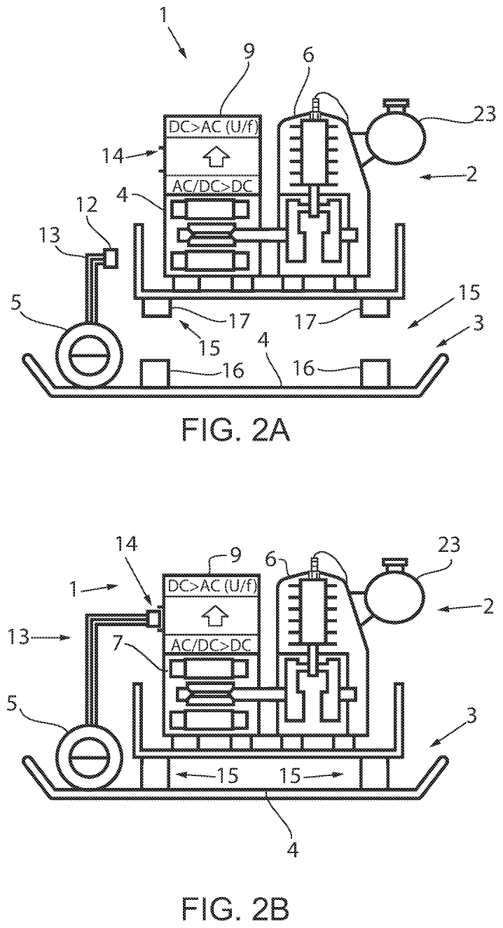

According to FIGS. 2A and 2B, a/the internal combustion engine 6 in turn drives a/the generator 7 which supplies electric power to the exciter 5. This power is fed into an electronics unit 9, or a current converter 9, in particular an AC/DC converter 9 and/or DC/AC converter 9. The type of current, i.e. AC or DC, suitable for operating the electric motor is advantageously provided here. Electric power storage units 8 here can be conjointly used for temporarily storing the generated current. Individual exciters 5, or combinations of a plurality of exciters 5, are again possible.

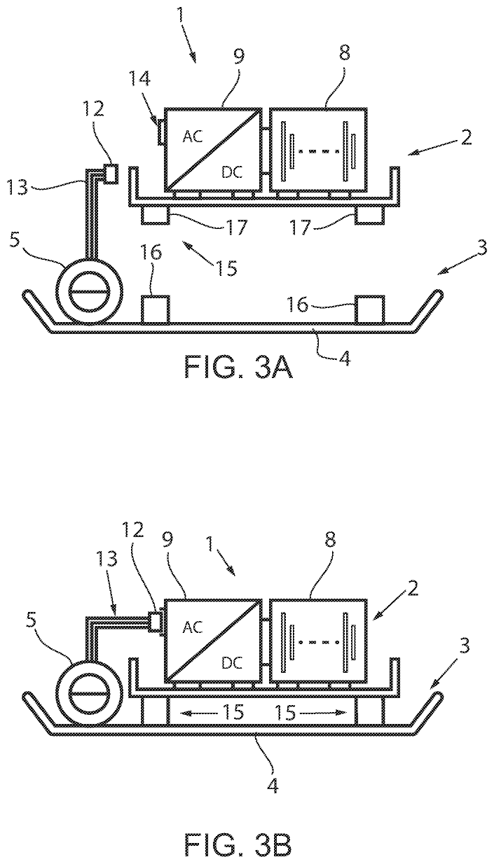

A further variant of the invention having one or a plurality of storage units 8, or rechargeable batteries 8, respectively, is illustrated in FIGS. 3A to 3B. The power storage unit 8 delivers the electric power to an electronics unit, or a current converter 9, respectively, which provides the type of current suitable for operating the electric motor of the exciter 5.

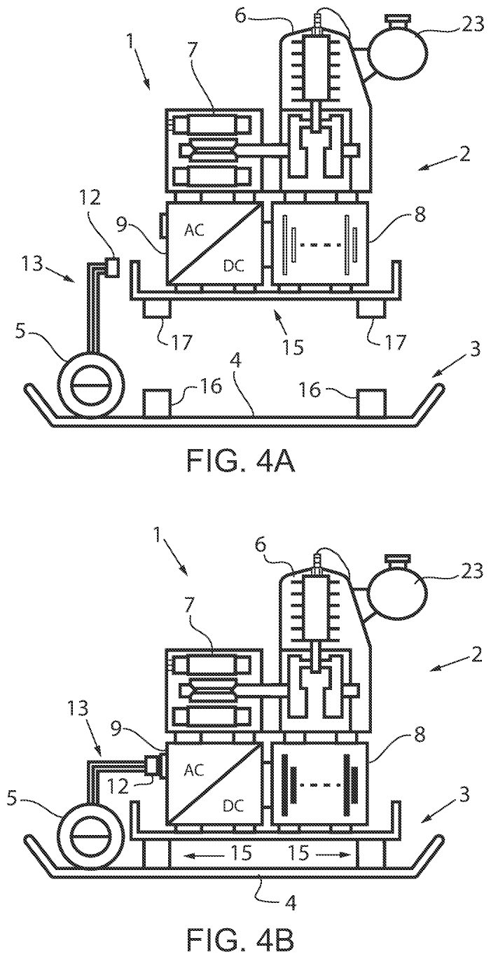

The variant according to FIGS. 4A and 4B differs from the variant according to FIGS. 2A and 2B substantially in that an additional storage battery, or a/the additional electric storage unit 8, respectively, is integrated in the power supply unit 2. This power module 2 thus has a so-called range extender by way of which a longer running time or operating time, respectively, is able to be implemented.

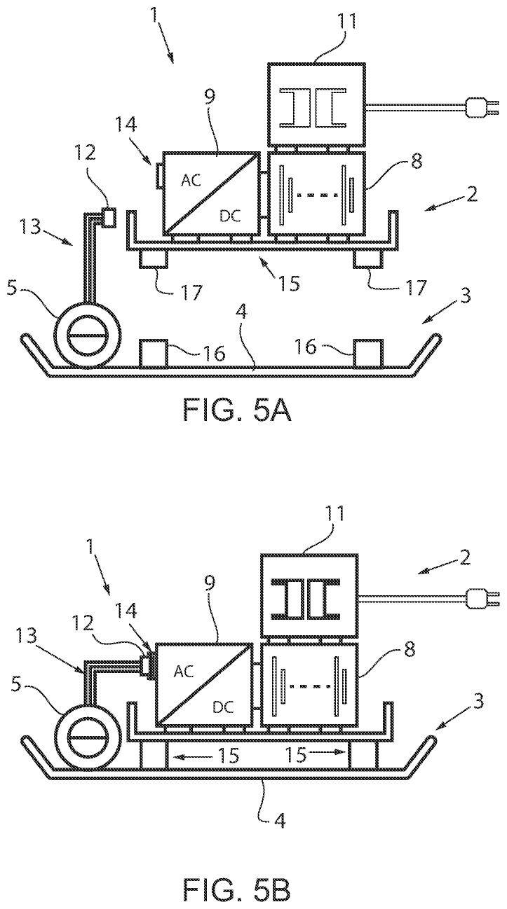

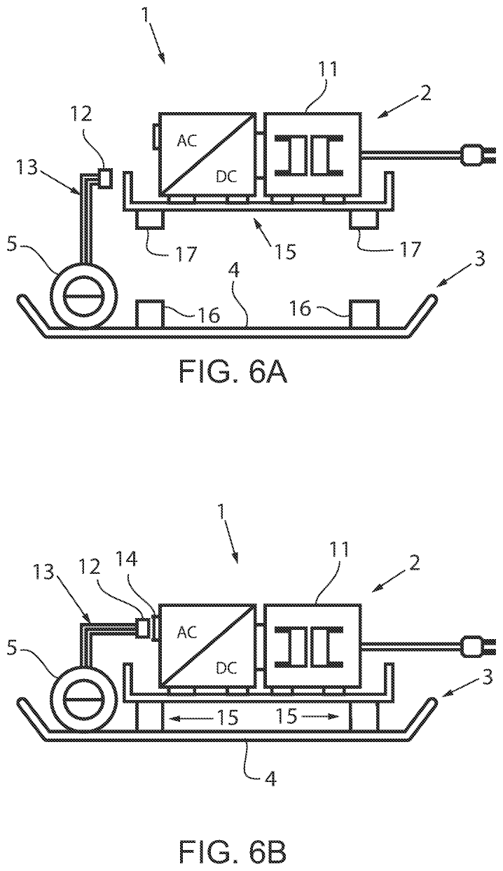

The exemplary embodiments according to FIGS. 5A to 6B advantageously have a mains connector 11 in order to implement a mains supply. Charging of the storage unit 8, or a temporary storage, respectively, and/or a direct supply of energy to the exciter 5 can be implemented here.

In principle, it is advantageous for the electric connection, or an electric plug connection 12, or an electric cable 13 having a plug 12 of the soil module 3, respectively, to be advantageously connected (without tools), for example in that the plug 12 can be plugged into a socket 14 of the power module 2 and unplugged again.

Alternatively or in combination, this electrical connecting can however also be implemented with the aid of an advantageous electric connection or coupling, respectively, not only by way of plugs, or in the usual manner by way of fixedly connected/plug cables, respectively, but this electric connection can also be implemented in a magnetic and/or capacitive (contactless) manner, for example. The two components of the plug/socket or of the first coupling device, respectively, to be connected can thus magnetically adhere/hold on to one another, and current, or electric power, respectively, for the drive motor or for the soil module 3, respectively, could moreover be transmitted by way of the magnetic contact faces.

Moreover, the soil module 3 and the power module 2 are advantageously connected to one another in a releasable manner via, for example, four fixing devices 15, or a buffers 15, respectively. The buffers 15 to this end optionally have in each case two buffer elements 16 and 17, wherein a lower buffer element 16 is firmly fixed to the soil module 3 and an upper buffer elements 17 is firmly fixed to the power module 2. The buffers 15, or buffer elements 16 and 17, respectively, have identical fixing spacings such that the different power modules according to FIGS. 1A-6B all are compatible with the soil module 3, or interchangeable, respectively.

A fixing not illustrated in more detail, for example a screw fitting, a bracing, a latching fit, or the like, for fixing the buffers 15, or the tool buffer element 16 and 17, respectively, to one another is not illustrated in more detail in FIGS. 1A-6B only for reasons of clarity.

According to the invention, a flexible system can thus be implemented as a kit in which as many identical parts as possible reduce the complexity and the costs of the overall machine. The machines illustrated possess identical soil modules 3, or lower masses, respectively, and electric exciters 5, independently of the drive source utilized for operating the machine.

The exciters 5 can have electric motors as a drive, or exciters 5 operating in a linear manner. The machine is completed in that an electric current source is installed/carried on board in the power module 2 or on the upper mass (one or a plurality of upper masses being possible), said current source providing the type of current suitable for driving the exciter motor.

Accordingly illustrated in FIGS. 7 and 8 is in each case a rammer 10, wherein the rammer soil module 30 comprises an electric oscillation exciter 50 having an electric motor. A power module 2 as alternative or interchangeable modules, respectively, comprises either an internal combustion engine 60 having a generator 70 and an optional converter 70, according to FIG. 8, or an electric storage unit 80 having an optional converter 90, according to FIG. 7, for supplying power to the exciter 50.

According to the invention here, the exciter 50 is fixedly integrated in the soil module 30; a frame 18 having a handle 19 is likewise integrated in the soil module 30 here. The mechanical fixing, or the fixing device 21, respectively, here is on the frame 18, and the electric plug connection 22 via the line 13 here is advantageously on the exciter 50.

According to the invention, a cost-effective and ecologically forward-looking kit system for vibratory plates and/or rammers can thus be implemented, in which the upper mass of the machine supports the mechanical or electric power source, and the lower mass supports the drive system and the oscillation exciter or exciters.

In the case of a plurality of vibration exciters 5, the latter when in operation can advantageously be individually switched on, switched off or toggled in order for the resulting motion vectors of the machine to be suitably controlled.

In various exemplary embodiments of the invention, the following are to be mentioned inter alia as particular advantages:
very simple and cost-effective construction;
no frequency inverters;
no start-up control of the vibration exciters 5 (because of the self-acting start-up of the asynchronous machine); and
no vector control (because of the auto-synchronization of the asynchronous machines in the energized operation).

The use of other types of motors for the vibration exciters 5 is of course also possible. For example, synchronous machines such as the synchronous reluctance motor, the switched reluctance motor or the BLDC motor may be used, wherein hybrids such as the reluctance motor, which represents a combination of the synchronous machine and an asynchronous machine, are also conceivable. Likewise possible are EC motors, DC machines, and universal motors.

It is moreover also noted that FIGS. 2A and 2B in principle describe the same approach as is schematically illustrated in FIGS. 1A and 1B, but the type of current generated by the internal combustion engine 6 with a generator 7 by way of an electronics unit is completely or partially converted to another type of current which advantageously enables the operation of the coupled vibration exciters 5, or renders the latter controllable.

FIGS. 3A and 3B in a similar manner describe the approach of FIGS. 2A and 2B, wherein the power required for operating the vibration exciters 5 is not supplied by an internal combustion engine 6 with a generator 7, but by one or a plurality of power storage units 8 which are assembled on the upper mass, or the power module 2, respectively, and have an electronics unit 9 connected thereto, according to FIGS. 2A and 2B. The power storage 8 assembled or present on the upper mass, respectively, can also be embodied so as to be removable.

FIGS. 4A and 4B furthermore describe a variant of FIGS. 3A and 3B, but a current generator is additionally used as a so-called range extender in order for the energy storage unit 8 to be recharged when required.

FIGS. 5A and 5B describe a machine which is comparable to that of FIGS. 3A and 3Bf and able to be connected to a grid that partially or completely handles the supply of the previously described vibration exciters 5 with electric power. The combination of an energy storage unit 8 and a charging unit is also possible here.

FIGS. 6A and 6B describe a machine which again is comparable to that of FIGS. 3A and 3B and is able to be connected to a grid that handles the supply of the previously described vibration exciters 5 with electric power.

Consequently, FIGS. 1A to 6B all also show a combination of a base machine, or a soil module 3, respectively, or an electric lower mass, respectively, and a “power box”, or power module 2 which is the upper mass or is in the latter and contains the power providers described in the context of FIGS. 1A to 6B, this combination being able to be carried out by a user of the vibratory plate 1, for example. Created as a result is a vibratory plate 1 which, depending on the task, can be correspondingly equipped by the operator on site.

In general, further advantageous variants or features, respectively, can be implemented individually and/or in combination with one another, respectively:
combination of independent systems composed of a rechargeable battery, a current inverter, a charger;
current inverter for generating, for example, 115 V/60 Hz, or 230 V/50 Hz, integrated in the rechargeable battery block, wherein the rechargeable battery block can furthermore be utilized as a mobile rechargeable battery;
optionally having a charging function for the dedicated rechargeable battery or else third-party rechargeable batteries;
combinations with H2 fuel cells;
use of DC voltage components (rechargeable battery—motor);
subdividing the lower mass into a plurality of lower masses; and/or
subdividing the upper mass into a plurality of upper masses—also as a third plane.

1. A soil compaction device for compacting a soil region, comprising:
a driven device comprising at least one of a vibration unit and an oscillation unit;
an electric motor that is configured to drive the driven device, wherein the electric drive motor is configured as one of an electric linear motor and as an electric motor having a rotor rotatable about a rotation axis;
at least one power supply unit that supplies the electric drive motor with electric power;
at least one of an electric plug device and a first coupling device releasably that electrically couples the electric drive motor and the power supply unit and that is provided between the electric drive motor and the power supply unit; and
a soil contacting unit comprising at least one soil contacting element, wherein the soil contacting element is configured to contact with the soil region, and wherein the soil contacting unit comprises at least the electric drive motor and the driven device; and
at least one of a fixing device and a second coupling device for releasably and mechanically coupling the soil contacting element of the soil contacting unit to the power supply unit, wherein the at least one of the fixing device and the second coupling device is provided between the soil contacting element of the soil contacting unit and the power supply unit.

2. The soil compaction device as claimed in claim 1, further comprising a flexible electric cable provided between at least one of the electric plug device and the first coupling device and the electric drive motor.

3. The soil compaction device as claimed in claim 1, wherein a spacing is provided between the at least one of the electric plug device and the first coupling device and at least one of the fixing device and the second coupling device such that the at least one of the electric plug device and the first coupling device and the at least one of the fixing device and the second coupling device are configured as separate components.

4. The soil compaction device as claimed in claim 1, wherein the power supply unit has at least one support frame, and further comprising at least one handle for holding the soil compaction device during an operating phase of the soil compaction device, the handle being disposed on the support frame.

5. The soil compaction device as claimed in claim 4, wherein at least one of the power supply unit and the support frame has at least a first fixing device of at least one of the fixing device and the second coupling device, wherein the soil contacting unit has a second fixing device, and wherein the first and the second fixing devices are able to be releasably fixed to one another.

6. The soil compaction device as claimed in claim 1, wherein the soil contacting unit is configured as a separately manageable soil module, and wherein the power supply unit is configured as a separately manageable, replaceable power module.

7. The soil compaction device as claimed in claim 1, wherein the power supply unit comprises at least one rechargeable electric storage unit.

8. The soil compaction device as claimed in claim 1, wherein the power supply unit comprises at least one internal combustion engine, the internal combustion engine being at least one of a diesel engine, a gas engine, and a turbine.

9. The soil compaction device as claimed in claim 1, wherein the power supply unit comprises at least one electric generator for converting dynamic energy to electric power.

10. The soil compaction device as claimed in claim 1, wherein the power supply unit comprises at least one inverter for converting DC to AC.

11. The soil compaction device as claimed in claim 1, wherein the power supply unit comprises at least one of a mains connector and a mains cable for connecting to a grid.

12. The soil compaction device as claimed in claim 1, wherein the power supply unit comprises at least one fuel cell unit for generating electric power from hydrogen or methane and at least one of oxygen and air.
